(19) United States
(12) Patent Application Publication
(10) Pub. No.: US 2020/0313758 A1
(43) Pub. Date: Oct. 1, 2020

(54) MASS TRANSITION OF SPECTRUM

(71) Applicants: SES AMERICOM, INC., Princeton, NJ (US); INTELSAT US LLC, McLean, VA (US)

(72) Inventors: Ammit Chawla, Washington, DC (US); Bronnie Fisher Fiely, Washington, DC (US); Thomas Mcnamara, Washington, DC (US); Christopher Mead, Washington, DC (US)

(21) Appl. No.: 16/836,738

(22) Filed: Mar. 31, 2020

Related U.S. Application Data
(60) Provisional application No. 62/827,834, filed on Apr. 1, 2019.

(51) Int. Cl. H04B 7/185; H04W 72/04

(52) U.S. Cl. CPC H04B 7/18519; H04W 72/0453; H04B 7/18513

(57) ABSTRACT

The exemplary embodiments are related to a system and methods of moving a plurality of existing customers of satellite services to new frequencies. The method includes determining a bandwidth capacity for the plurality of existing customers; determining specifications for a filter for each of the existing customers based on at least the bandwidth capacity, wherein the filter is configured to prevent wireless signals from interfering with satellite services of one of the existing customers; determining the filters have been installed at each of the plurality of existing customers; and moving the plurality of existing customers from a first set of frequencies to a second set of frequencies.

### PRIORITY CLAIM

The present disclosure claims priority to U.S. Provisional Patent Application Ser. No. 62/827,834 filed on Apr. 1, 2019 and hereby incorporates the above provisional application, in its entirety, herein.

### BACKGROUND INFORMATION

The present disclosure relates to rapidly repurposing a significant amount of spectrum currently used for satellite services in the continental United States and, more particularly, to a method of transitioning a mass of incumbent customers from one part of the satellite spectrum to a different part of the satellite spectrum to free up spectrum for terrestrial uses.

Many high frequency bands are available for possible use. However, high frequency signals are not always desirable because, for example, high frequency bands do not penetrate structures (e.g. buildings) well, do not travel long distances (when compared to low frequency signals), etc. Low frequency bands may address these shortcomings. However, availability of low frequency bands is extremely limited.

Mid-band frequencies such as, for example, 3700-4200 MHz, which are also known as C-band frequencies, exhibit the desirable characteristics of the low frequency bands (e.g., travel distance, penetration characteristics) and high frequency bands (e.g., the quantity of bands available for use). This frequency band has been allocated by the Federal Communication Commission (FCC) to satellite operators. Satellite operators use geosynchronous satellites and corresponding ground segments to provide fixed satellite service (FSS) over C-band frequencies. FSS is a point-to-multipoint service that provides customers with a wide range of global communications services including, media, telecommunications, enterprise, mobility, and government services. For example, FSS is used to deliver programming such as the Super Bowl, the World Cup, and the Olympics to over one hundred million households across the country. Broadcast feeds also include, for example, network and syndicated programs, live news coverage, and other programming. FSS allows video programming transmitted from a single satellite covering all lower 48 states to reach multiple distributors at once. These distributors then re-transmit the signals to end users. The C-band includes a set of paired frequency bands such as, for example, 5925-6425 MHz for communications in the Earth-to-space direction and 3700-4200 MHz for communications in the space-to-Earth direction.

FIG. 1 provides an example of a geostationary FSS. In FIG. 1, content providers 100, including national content originators 100a and regional content originators 100b, originate content, which is transmitted using the upper frequency band to a satellite 110. The satellite 110 then transmits the content to a network operation center (NOC) 120 and to a headend receiver 130 using the lower frequency band. The NOC 120 and the headend receiver 130 then retransmit the content via fiber, wireline, or wireless terrestrial communication to various nodes 140, which then transfer the content to end user locations 150.

Recently, there has been keen interest in so-called 5^{th} generation (5G) wireless systems and associated technology. Worldwide, wireless operators regard the C-band spectrum as ideal for 5G terrestrial communication deployment due to the unique technical characteristics of the C-band—capable of carrying significant amounts of data like high-band frequencies, while also propagating widely like low-band frequencies. In particular, the lower frequency band (3.7 GHz-4.2 GHz) of C-band that is used on a non-exclusive basis by multiple satellite operators for downlinking transmissions from space-to-Earth has been identified as an ideal frequency band location for 5G terrestrial communication services in the United States.

The C-band is used by incumbent satellite operators to provide services to long-established customers. 5G wireless communications and satellite communications are relatively incompatible, and numerous studies have confirmed that terrestrial mobile services cannot coexist on a co-frequency, co-coverage basis in C-band downlink FSS. The need to protect the large number of earth stations that receive content transmitted by existing customers in the C-band while introducing 5G terrestrial services presents very complex sharing issues. The satellite earth stations (for example, the NOCs 120 and the headend receivers 130) must discriminate very low power signals received from the satellites at the earth from the higher power transmissions used by 5G wireless devices in and around these locations which cause interference with the satellite downlink signals. This is exacerbated by the large, ubiquitous deployment of terrestrial mobile services. The problem is particularly acute in large urban areas where 5G deployment is expected to be extensive.

A satellite capable of offering FSS includes a payload composed of transponders, antennas and switching systems, engines used for maintaining the geostationary position, tracking systems, power systems and command and control systems for receiving commands from ground control stations. The number of C-band transponders on a satellite may vary, but typically there are 24 transponders per satellite. Each transponder may carry a plurality of different feed signals; the number of feed signals depending on the content—for example, standard definition (SD), high definition (HD) or 4K (UHD) television. A transponder operates at a single polarization and frequency reuse is typically employed by pairing two frequency transponders with opposite polarizations. C-band transponders typically use 36 MHz and include a small guard band between each transponder.

Periodically, satellite operators may move an individual customer's transmissions from one transponder to another transponder, which normally occurs when a satellite is replaced with a new satellite. However, such movement is typically one-to-one with regards to the specific frequencies used and is a fairly simple process. The process of relocating a customer from one set of frequencies on a transponder to another set of frequencies or on a different polarization on a different transponder, or to a different satellite, is a more difficult process. With the increased interest in nationwide deployment of 5G wireless communication as soon as possible, there is a need for a method to quickly and efficiently transition a large number of disparate incumbent customers of multiple satellite operators to free up a contiguous portion of the lower frequency band while protecting the legacy services of these disparate customers.

### SUMMARY

Some exemplary embodiments include a method of moving a plurality of existing customers of satellite services to new frequencies. The method includes determining a bandwidth capacity for the plurality of existing customers; determining specifications for a filter for each of the existing customers based on at least the bandwidth capacity, wherein the filter is configured to prevent wireless signals from interfering with satellite services of one of the existing customers; determining the filters have been installed at each of the plurality of existing customers; and moving the plurality of existing customers from a first set of frequencies to a second set of frequencies.

Other exemplary embodiments include a system having a memory storing information corresponding to a plurality of existing customers of satellite services; a processor configured to determine a bandwidth capacity for the plurality of existing customers based on the information, determine specifications for a filter for each of the existing customers based on at least the bandwidth capacity, wherein the filter is configured to prevent wireless signals from interfering with satellite services of one of the existing customers, determine the filters have been installed at each of the plurality of existing customers, wherein after the filters have been installed the plurality of existing customers are moved from a first set of frequencies to a second set of frequencies.

### BRIEF DESCRIPTION OF THE DRAWINGS

FIG. 1 depicts a geostationary fixed satellite service (FSS) system;

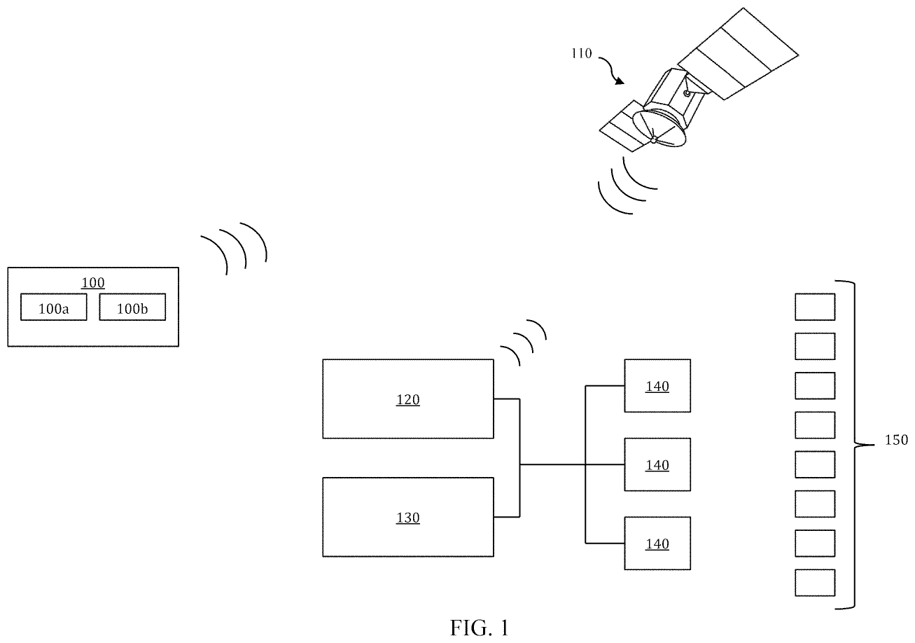

FIG. 2 is a flowchart illustrating a method of determining tranches in accordance with embodiments of the present disclosure;

FIG. 3 is a flowchart illustrating a method of transitioning incumbent customers to new frequencies in accordance with embodiments of the present disclosure;

FIG. 4 is a flowchart illustrating a method of moving a plurality of customers to new frequencies in accordance with embodiments of the present disclosure;

FIG. 5 is a flowchart illustrating a method of moving a plurality of customers to new frequencies in accordance with embodiments of the present disclosure;

FIG. 6 depicts a system configured to move a plurality of customers to new frequencies in accordance with embodiments of the present disclosure; and

FIGS. 7A AND 7B show exemplary screenshots of the visualization provided by the EDV tool.

### DETAILED DESCRIPTION

The exemplary embodiments may be further understood with reference to the following description and the related appended drawings, wherein like elements are provided with the same reference numerals. The exemplary embodiments relate to transitioning a mass of incumbent customers from one part of the satellite spectrum to a different part of the satellite spectrum to free up spectrum for terrestrial uses.

In the United States, the Federal Communications Commission (FCC) licenses bands of spectrum to commercial users according to the service allocations found in the United States Table of Allocations. The commercial users may be, for example, satellite operators or mobile base station owners. The commercial users then allocate portions of the licensed spectrum within a particular band for their customers' use. As new technologies arise, the FCC may create new allocations or reallocate previously allocated spectrum to new services, particularly in situations where a new service cannot easily co-exist with incumbent services that already have rights to use the spectrum. This reallocation can result in a need to move a large number of commercial users and their customers from one part of the spectrum to new portions of the spectrum to free up a portion of the spectrum for use by the new technologies. It should be noted that the use of the term “customer” herein can refer to any of commercial users, customers of commercial users, affiliates, or any user of satellite services in the affected spectrum.

Below, an exemplary method of freeing up a portion of the C-band spectrum used by incumbent satellite operators for downlink transmissions will be described. However, it should be noted that the present disclosure is not limited to this exemplary method, and the exemplary embodiments may be applicable to freeing up spectrum within other frequency bands that may have technological conflicts with new technologies and services.

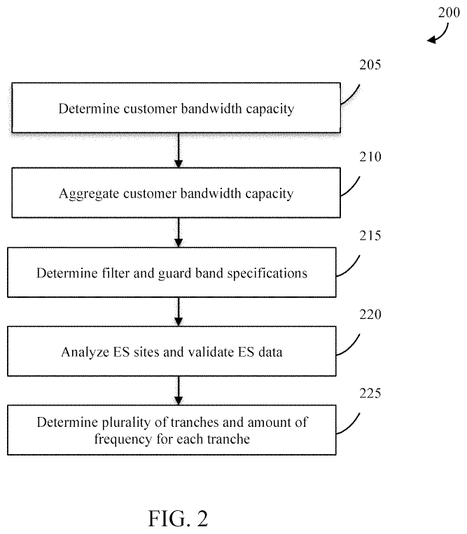

FIG. 2 is a flowchart showing an exemplary method 200 of determining tranches in accordance with embodiments of the present disclosure. A tranche may be defined as an amount of spectrum that can be cleared at a given time. For example, in some embodiments, the method 200 may clear two tranches: a first tranche of 120 MHz from 3700-3920 MHz which is anticipated to be free of satellite transmissions by a first predetermined date (e.g., at the end of 18 months); and a second tranche of an additional 180 MHz from 3920-4000 MHz which is anticipated to be free of satellite transmissions by a second predetermined date (e.g., at the end of 36 months).

As depicted in FIG. 2, at 205, customer bandwidth capacity is determined for all current customers. For example, current customers may have rights to a given set of frequencies for a given period of time, and/or within a given geographical area or areas. Typically, these rights are based on contractual relationships between the satellite provider and the individual customer. Some rights may be expiring and other rights may be due for renewal. Additionally, the determination may take into account the type of customer. For example, some customers, such as broadcast content distributors, cannot tolerate downtime in their transmissions. Other customers, such as occasional use customers, may be more accepting of transmission downtime. Still other customers, such as enterprise service customers, may be accepting of transmission downtime at specific times—for example, transmission downtime during a weekend or certain days of the week may be more acceptable than transmission downtime during the week.

At 210, customer bandwidth capacity is aggregated for the plurality of customers. The aggregation provides an understanding of the current situation among all customers and across multiple satellite operators.

At 215, filter(s) and guard band specifications are determined. Generally, there are several different ways to prevent interference between terrestrial and satellite communications. One method is to use a filter, which allows a very low power reception signal to be received by filtering out interfering signals. Alternatively, or in addition to using a filter, a guard band may be utilized, which is dead space that is unused for either terrestrial or satellite communications. In some embodiments, both solutions—filters and a guard band—are used simultaneously to reduce interference. It should be noted that higher quality filters allow for a smaller guard band to be used. On the other hand, larger guard bands allow for lower quality filters to be used.

At 220, earth station (ES) sites are analyzed and earth station data from the ES sites is validated, using an enhanced database and visualization (EDV) tool. This operation may include analyzing geographic coverage. For example, as described above, FSS is a point to multi-point service. Therefore, any earth station within the geographical coverage of the satellite transmission may receive the transmission. Some customers, such as a cruise lines, may receive the satellite transmission both in international waters, where interference with terrestrial broadcast is not an issue, and at other locations while docked, where such interference is problematic. This analysis takes into account such customers that may have multiple geographical considerations. In some embodiments, this geographical analysis additionally or alternatively may be performed in 205.

The EDV tool may, for example, be implemented as software program code stored in a memory and executed by one or more microprocessors of a computing device. In some embodiments, the EDV tool is configured to access an external database that stores the earth station data for the ES sites, analyzes and validates the data, and displays the validated data on a display device associated with the computing device. The database may be the International Bureau Application Filing and Reporting System (IBFS) database, which is maintained by the FCC. The FCC does not require receive sites to be registered. As such, the FCC database does not include, nor do satellite operators have, accurate data on the geographical locations of all earth stations that are receiving services. The EDV checks services on the periphery of the satellite coverage areas to ensure that no international services are received in the continental United States. This analysis and validation allow for a determination of which customer services may be prioritized, moved, etc.

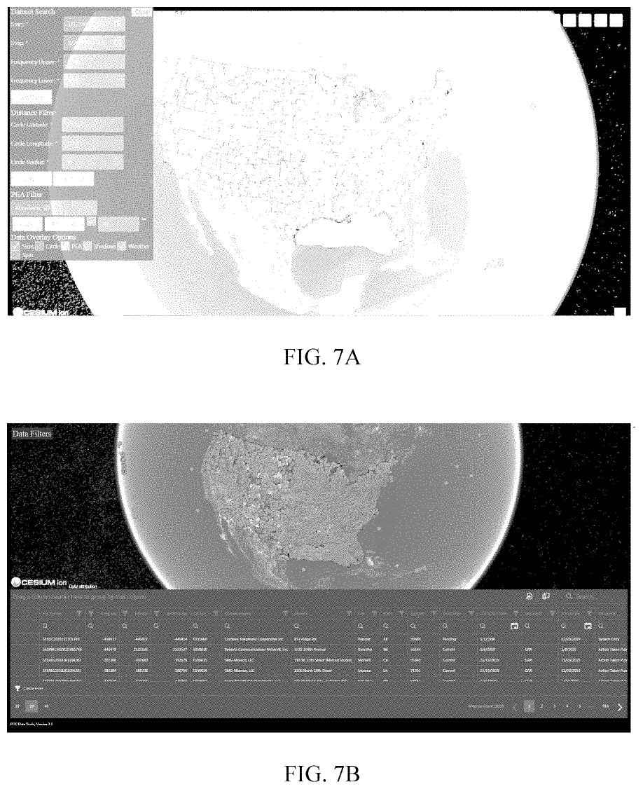

In some embodiments, the EDV tool may also overlay Partial Economic Areas (PEAs), which are FCC defined boundaries in which spectrum may be sold, on top of the FCC IBFS data, which does not include such data, on the display device. By visualizing this data on a world map, the EDV tool may identify and count the number of earth stations in a PEA. FIGS. 7A AND 7B show exemplary screenshots of this visualization provided by the EDV tool.

In some embodiments, the EDV tool may also utilize imagery software and services to perform virtual site surveys of the sites to determine a number of antennas at each ES site through satellite imaging of the ES sites. Based on this analysis, the number of filters that may be installed can be determined. As a result, an estimate of the production and installation times for the filters and, in particular, a determination of how many filters can be installed within different times periods (e.g., within 18 months, within 36 months, etc.) can be determined. The EDV tool data and analysis combined with the estimate of the number of antennas per site for each type of site allows for an estimation of how many sites could be updated with filters for a given movement of spectrum and ultimately, how many PEAs could be supported for an early tranche.

At 225, a plurality of tranches and an amount of frequency for each tranche is determined. The number of tranches may be determined based on the results from 205-220. In addition, an amount of frequency for each tranche may be determined based on the results of 205-220. For example, with improved filtering, the guard band may be decreased, thus allowing for more bandwidth to be freed up. Some customers who have expiring rights, rights that are decreasing, or that are occasional use customers may be included in a first tranche. Other customers, for example continuous broadcasters sharing the same satellite, may be moved at the same time due to the characteristics of their transmissions, and thus should be included in a same tranche, etc. The movement of tranches is determined by which customers currently utilize a part of the band that needs to be cleared.

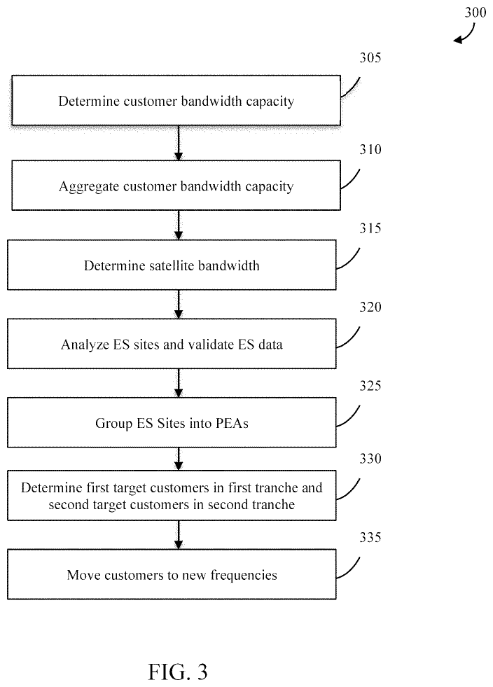

FIG. 3 is a flowchart showing a method 300 of transitioning incumbent customers to new frequencies in accordance with embodiments of the present disclosure. As shown in FIG. 3, at 305, customer bandwidth capacity for all current customers is determined. The customer bandwidth capacity may include both existing customer bandwidth usage, as well as planned bandwidth capacity needs for a predetermined period of time. The correct identification of customer bandwidth capacity, both presently and for a predetermined period of time in the future (for example, a time at which 5G wireless technology is expected to be commercially deployed) allows an understanding of the amount of the frequency band of the C-band spectrum that must be cleared for 5G wireless usage without pushing existing satellite customer services out of the C-band.

At 310, the customer bandwidth capacity is aggregated for the plurality of customers. Unlike typical transitions, in which a single customer is transitioned, a plurality of customers may be transitioned together using the exemplary embodiments. Thus, the customer bandwidth capacity is aggregated across the plurality of customers to forecast aggregate customer bandwidth requirements.

At 315, the satellite bandwidth capacity is determined. The satellite bandwidth capacity may include the usage of bandwidth across the lower frequency band, i.e., 3700-4200 MHz, of the C-band spectrum. In some embodiments, the usage may include both transponders that are in use at a current time and/or planned for use within a predetermined period of time, and transponders that are not in use at the current time and/or planned to be freed within the predetermined period of time. In some embodiments, the satellite bandwidth capacity may include bandwidth capacity of each of a plurality of existing satellites that are already in geosynchronous orbit. In some embodiments, this operation may further include determining (1) whether additional satellites need to be deployed to meet the aggregate customer bandwidth requirements, (2) specifications of such additional satellites, and (3) whether existing satellites currently in orbit can take on any overflow capacity. In some embodiments, the specifications may include an indication of whether the satellites are C-band-only spacecraft with fewer frequencies available for use than a typical C-band satellite, encoding methods to be handled by the satellites, geographic coverage of the satellites, etc.

At 320, ES sites are analyzed and earth station data from the ES sites is validated, using an EDV tool. As noted above, the EDV tool may, for example, be implemented as software program code stored in a memory and executed by one or more microprocessors of a computing device. The EDV tool may access an external database storing the earth station data for the ES sites, analyze and validate the data, and display the validated data on a display device.

In some embodiments, the ES sites may include, for example, satellite network operation center (NOC) sites and cable head end sites. The earth station data may include, for example, an identification of the type of distribution entity using the ES site, a number of antennas per site including a type of the antennas, a number of head end sites, a number of complex, multi-feed antennas at each site, etc. More complex, multi-feed antennas are able to receive downlink signals from various transponders on a plurality of satellites. In contrast, a less complex, single feed antenna may require that a new antenna be installed at the ES site in order to implement the transition to a transponder and/or satellite at a new frequency band.

At 325, the ES sites are grouped into a plurality of PEAs using the EDV tool. The PEA is the area in which widespread 5G wireless deployment is expected to occur. For example, a PEA may be centered on Orlando; another PEA may be centered on Boston; another PEA may be centered on Houston, etc. In some embodiments, this operation may include identifying ES sites within a certain distance from a PEA boundary. Since the PEAs are in areas in which widespread 5G wireless deployment is expected, the PEAs may be used to determine which filters to apply at the various ES sites within the PEA area, as will be described later.

At 330, first target customers in a first tranche and second target customers in a second tranche are determined from among a plurality of customers. The first tranche may be a first amount of bandwidth within the lower frequency band of the C-band spectrum, and the second tranche may be a second amount of bandwidth within the lower frequency band of the C-band spectrum. In some embodiments, for example, the first tranche may be 100 MHz with a 20 MHz guard band (e.g., 120 MHz total), and the second tranche may be 280 MHz with a 20 MHz guard band (e.g., 300 MHz total). In some embodiments, the first tranche may be, for example, from 3700-3820 MHz with 3700-3800 MHz being made available to 5G wireless communication with a 3800-3820 MHz guard band, and the second tranche may be, for example, from 3700-4000 MHz with 3700-3980 MHz being made available to 5G wireless communication with a 3980-4000 MHz guard band. It should be noted, however, that these values are only examples and that the first and second tranches may have different band values in the C-band.

The first target customers in the first tranche frequencies and the second target customers in the second tranche frequencies may be determined based on one or more factors such as: existing satellite bandwidth capacity, individual customer bandwidth capacity of each of the customers, aggregate customer bandwidth capacity of the plurality of customers, additional satellite capacity to be brought on-orbit, the ES data, the PEAs, and/or a timeframe. In other words, the plurality of customers with legacy services operating in the 3700-4000 MHz hand may be grouped into the first tranche or the second tranche based on one or more of the factors listed above.

At 335, the plurality of customers are moved to new frequencies assigned to the first tranche and the second tranche. In some embodiments, the first target customers in the first tranche may be moved to new frequencies within a first timeframe, and the second target customers may be moved to new frequencies within a second timeframe. In some embodiments, the second timeframe may begin after the first timeframe expires. The use of timeframes allows for a staged allotment of portions of the lower frequency band of the C-band spectrum to 5G wireless use. For example, a first portion of the lower frequency band of the C-band spectrum freed up for 5G wireless use rapidly, followed by a second portion of the lower frequency band.

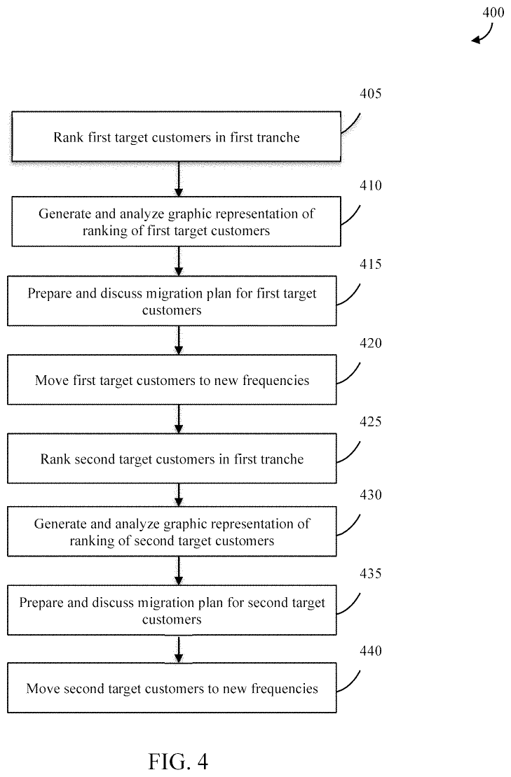

FIG. 4 is a flowchart illustrating an example of 335 of the method 300 illustrated in FIG. 3 in more detail, in accordance with embodiments of the present disclosure.

At 405, the first target customers in the first tranche may be ranked based on one or more factors such as, for example, existing satellite bandwidth capacity, individual customer bandwidth capacity of each of the customers, aggregate customer bandwidth capacity of the plurality of customers, the ES data, the PEAs, and/or a time within the first timeframe.

At 410, a graphical representation of ranking of the first target customers is generated and analyzed with respect to time to confirm that the movement within the first timeframe is achievable.

At 415, for each of the first target customers, a migration plan is prepared and discussed with the customer. In some embodiments, the migration plan may include a timing of the migration, new frequencies, and new location (i.e., specific frequency range on specific satellite) for the customer.

At 420, the first target customers are moved to the new frequencies in accordance with their respective migration plans.

At 425, the second target customers in the second tranche are also ranked based on one or more factors such as, for example, existing satellite bandwidth capacity, individual customer bandwidth capacity of each of the customers, aggregate customer bandwidth capacity of the plurality of customers, the ES data, the PEAs, and/or a time within the second timeframe.

At 430, a graphical representation of ranking of the second target customers is generated and analyzed with respect to time to confirm that the movement within the second timeframe is achievable.

At 435, for each of the second target customers, a migration plan is prepared and discussed with the customer. In some embodiments, the migration plan includes a timing of the migration, new frequencies, and new location (i.e., specific frequency range on specific satellite) for the customer.

At 440, the second target customers are moved to the new frequencies in accordance with their respective migration plans.

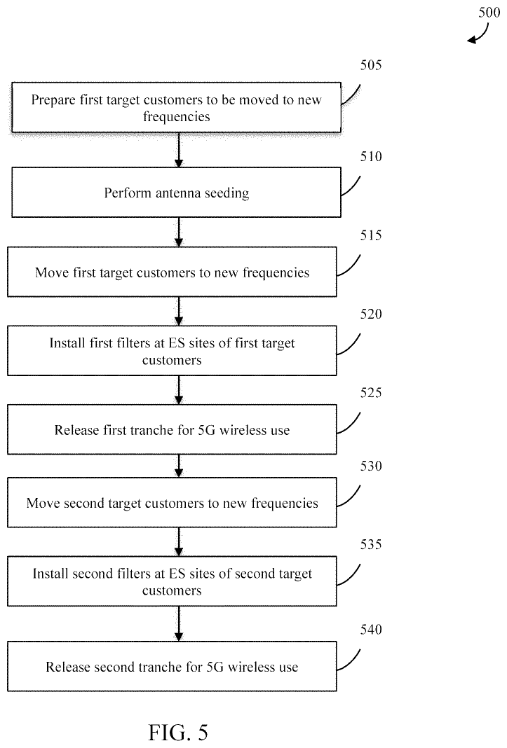

FIG. 5 is a flowchart illustrating another example of 335 of the method 300 illustrated in FIG. 3 in more detail, in accordance with embodiments of the present disclosure.

At 505, the first target customers are prepared to be moved to the new frequencies. For example, the first target customers may be notified about which, if any, of the customer's existing feeds will be relocated to a new frequency range on a new transponder and whether that feed will be on the same satellite or on a new satellite.

At 510, antenna seeding is performed. In some embodiments, the antenna seeding may be performed based on the ES data for the customer. For example, ES sites of some customers will already have antennas which may easily be retuned to a new transponder on the same satellite or may easily be repointed to a new transponder on a new satellite.

However, ES sites of other customers may not have spare antennas. For these sites, antennas may be supplied. That is, additional antennas may be provided to the customer at this ES site in order to allow that ES site to receive feeds from a new transponder on a satellite they are currently not addressing.

At 515, the first target customers are moved to new frequencies within a first time period. For example, the first time period may be 18 months. During the first time period, a signal is simultaneously transmitted both on the old frequencies and the new frequencies for the first target customers (i.e., dual illumination), while the ES sites of customers' customers (i.e., affiliates) receiving from the first target customers are retuned or repointed.

At 520, first filters may be installed at ES sites of the first target customers. In some embodiments, the first filters may be, for example, 100×20 MHz filters. However, other filters may alternatively be utilized. For example, if the first tranche T1 corresponds to 100 MHz with a 20 MHz guard band, 100×20 MHz filters may be installed for all downlink services operating in the range of 3820-4000 MHz.

In some embodiments, second filters may be also be installed within the first time period for downlink services of third target customers who are already in the 4000-4200 MHz portion of the lower frequency band of the C-band spectrum and who will not be moving. In some embodiments, ES sites of the third target customers in the PEAs included in the first tranche T1 will be provided with second filters within the first time period. In some embodiments, the second filters may be 280×20 MHz filters. These filters prevent 5G wireless transmissions from interfering with the downlink services. In some embodiments, the first filters (i.e., 100×20 MHz) may also be installed at ES sites of the third target customers depending on the types of services they need.

At 525, the first tranche is released for 5G wireless use after the first time period expires and the first filters have already been installed at affected ES sites of the first target customers' customers (i.e., affiliates).

At 530, the second target customers are moved to new frequencies within a second time period. In some embodiments, the second time period may be measured from the end of the first time period. For example, the second time frame may be 36 months. During the second time period, signal is simultaneously transmitted both on the old frequencies and the new frequencies of the second target customers (i.e., dual illumination), while the ES sites receiving from the second target customers are retuned or repointed.

At 535, second filters may be installed at ES sites of the second target customers' customers (i.e., affiliates). In some embodiments, the second filters may be 280×20 MHz filters as described above, since the second tranche T2 corresponds to 280 MHz with a 20 MHz guard band. Additionally, the first filters previously installed for the first target customers' customers (i.e., affiliates) in or near certain ones of the top 50 PEAS may be changed to the second filters. Moreover, during this time, second filters may additionally be installed within the second time period for downlink services of some of the third target customers who are already in the 4000-4200 MHz portion of the lower frequency band of C-band spectrum and who did not move and will not be moving.

At 540, the second tranche is released for 5G wireless use after the second time period expires and the second filters have already been installed at affected ES sites receiving from the second target customers' customers (affiliates).

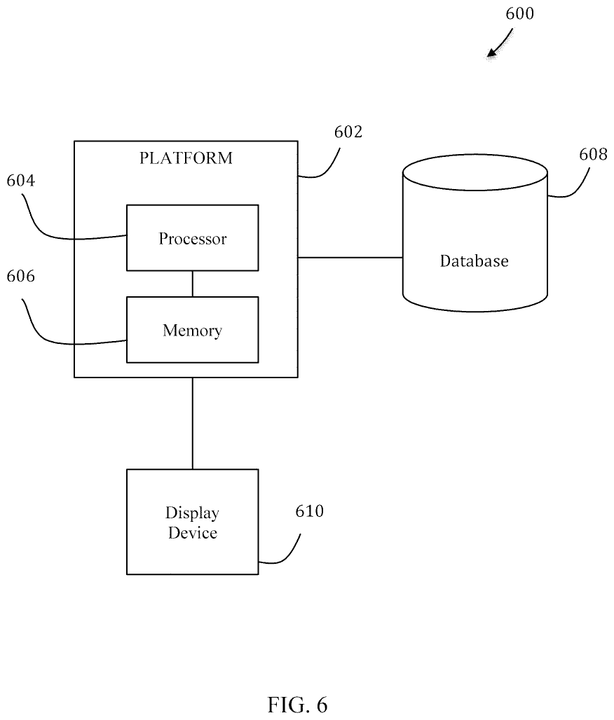

FIG. 6 depicts a system 600 configured to move a plurality of customers to new frequencies in accordance with embodiments of the present disclosure. In some embodiments, for example, the system 600 may be the EDV tool described above. In some embodiments, the system 600 includes a platform 602 having a processor 604 configured to execute a set of instructions stored on a memory 606. The set of instructions may be one or more of the methods 200, 300, 400, and/or 500 described above. The memory 606 may further include information corresponding to a plurality of existing customers of satellite services. In some embodiments, the system may further include a database 608. The database 608 may include one or more of IBFS data, PEA data, ES data, etc., which is utilized by the platform 602. The system 600 may further include a display device 610 configured to display data to a user. For example, the display device 610 may be used to display the validated ES data in addition to PEA data overlaid on top of the IBFS data, as described above.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed is:

1. A method of moving a plurality of existing customers of satellite services to new frequencies, the method comprising:
determining a bandwidth capacity for the plurality of existing customers;
determining specifications for a filter for each of the existing customers based on at least the bandwidth capacity, wherein the filter is configured to prevent wireless signals from interfering with satellite services of one of the existing customers;
determining the filters have been installed at each of the plurality of existing customers; and
moving the plurality of existing customers from a first set of frequencies to a second set of frequencies.

2. The method of claim 1, further comprising:
determining a guard band for at least one of the existing customers based on at least the bandwidth capacity, wherein, when the at least one of the existing customers is moved to the second set of frequencies, the guard band is implemented for the at least one of the existing customers.

3. The method of claim 1, wherein determining the bandwidth capacity includes determining a period of time during which the plurality of existing customers have rights to use the first frequency band.

4. The method of claim 1, further comprising:
identifying earth station locations and partial economic area locations; and
determining how any filters can be installed at the earth station locations within a predetermined period of time.

5. The method of claim 1, further comprising:
determining a plurality of tranches and an amount of frequency for each tranche, wherein each tranche is a subset of the plurality of existing customers.

6. The method of claim 5, further comprising:
determining a timing for moving each of the plurality of tranches to the second set of frequencies, wherein the timing for each movement is based on one or more predetermined factors.

7. The method of claim 6, wherein the one or more predetermined factors include one or more of expiration date of existing customer rights to the first set of frequencies, a type of existing customer, the frequency with which the existing customer utilizes the first set of frequencies, and a geographical location of the existing customer.

8. The method of claim 5, wherein the plurality of tranches includes a first tranche and a second tranche, and wherein a first amount of frequency allocated to the first tranche is 120 MHz and the second amount of frequency allocated to the second tranche is 300 MHz.

9. The method of claim 8, wherein the first amount of frequency is 100 MHz with a 20 MHz guard band, and wherein the second amount of frequency is 280 MHz with a 20 MHz guard band.

10. The method of claim 1, further comprising:
determining aggregate customer bandwidth requirements;
determining satellite bandwidth capacity; and
determining whether the satellite bandwidth capacity meets the customer bandwidth requirements, wherein, when the satellite bandwidth capacity does not meet the customer bandwidth requirements, additional satellites are deployed.

11. A system, comprising:
a memory storing information corresponding to a plurality of existing customers of satellite services;
a processor configured to determine a bandwidth capacity for the plurality of existing customers based on the information, determine specifications for a filter for each of the existing customers based on at least the bandwidth capacity, wherein the filter is configured to prevent wireless signals from interfering with satellite services of one of the existing customers, determine the filters have been installed at each of the plurality of existing customers, wherein after the filters have been installed the plurality of existing customers are moved from a first set of frequencies to a second set of frequencies.

12. The system of claim 11, wherein the processor is further configured to determine a guard band for at least one of the existing customers based on at least the bandwidth capacity, wherein, when the at least one of the existing customers is moved to the second set of frequencies, the guard band is implemented for the at least one of the existing customers.

13. The system of claim 11, wherein the processor determines the bandwidth capacity based on at least determining a period of time during which the plurality of existing customers have rights to use the first frequency band.

14. The system of claim 11, wherein the processor is further configured to identify earth station locations and partial economic area locations and determine how many filters can be installed at the earth station locations within a first predetermined period of time.

15. The system of claim 11, wherein the processor is further configured to determine a plurality of tranches and an amount of frequency for each tranche, wherein each tranche is a subset of the plurality of existing customers.

16. The system of claim 15, wherein the plurality of tranches includes a first tranche and a second tranche, and wherein a first amount of frequency allocated to the first tranche is 120 MHz and the second amount of frequency allocated to the second tranche is 300 MHz.

17. The system of claim 16, wherein the first amount of frequency is 100 MHz with a 20 MHz guard band, and wherein the second amount of frequency is 280 MHz with a 20 MHz guard band.

18. The system of claim 11, wherein the processor is further configured to determine a timing for moving each of the plurality of tranches to the second set of frequencies, wherein the timing for each movement is based on one or more predetermined factors.

19. The system of claim 18, wherein the one or more predetermined factors include one or more of expiration date of existing customer rights to the first set of frequencies, a type of existing customer, the frequency with which the existing customer utilizes the first set of frequencies, and a geographical location of the existing customer.

20. The system of claim 11, wherein the processor is further configured to determine aggregate customer bandwidth requirements, determine satellite bandwidth capacity, and determine whether the satellite bandwidth capacity meets the customer bandwidth requirements, wherein, when the satellite bandwidth capacity does not meet the customer bandwidth requirements, additional satellites are deployed.
